(19) United States
(12) Patent Application Publication
(10) Pub. No.: US 2006/0214860 A1
(43) Pub. Date: Sep. 28, 2006

(54) Vehicle roof antenna mounting assembly

(76) Inventors: Makoto Hayashi, Tokyo (JP); Toshiro Yokoyama, Tokyo (JP); Jinsong Wang, Tokyo (JP)

Correspondence Address: MCGLEW & TUTTLE, PC, P.O. BOX 9227, SCARBOROUGH STATION, SCARBOROUGH, NY, 10510-9227, US

(21) Appl. No.: 11/374,561

(22) Filed: Mar. 13, 2006

(30) Foreign Application Priority Data
Mar. 14, 2005 (JP) 2005-071528

(51) Int. Cl. H01Q 1/32

(52) U.S. Cl. 343/713

(57) ABSTRACT

The vehicle roof antenna mounting assembly comprises a convex portion (120), a bolt (160) and a leg washer (140). The convex portion is inserted into a mounting hole (RH) of a vehicle roof panel (R) and has a edge portion (125) and a inner threaded hole (126). The bolt has a screw screwed to the threaded hole and is tightened to the convex portion. The leg washer has a plate washer ring (141), a leg portion (142) and a taper portion (144). The leg portion is extendedly provided from the washer ring toward the mounting hole. The taper portion is provided on the leg portion as opposed to the edge portion and abutted on the edge portion to expand the tip portion toward an outside of the mounting hole.

### RELATED APPLICATION

This application relates to and claims a priority from corresponding Japanese Patent Application No. 2005-071528 filed on Mar. 14, 2005.

### BACKGROUND OF THE INVENTION

1. Field of the Invention

The present invention relates to a vehicle roof antenna mounting assembly, and more particularly to a vehicle roof antenna mounting assembly in which operability for mounting it to a vehicle roof panel is taken into consideration.

2. Description of the Related Art

A conventional general vehicle roof antenna mounting assembly is that an antenna base plate is fixed by fitting a convex portion formed on an undersurface of the antenna base plate into a perforated portion formed on a vehicle roof panel and screwing with a nut, etc. from a vehicle interior. This is disclosed in, for example, Japanese Patent Application Kokai Publication No. 2001-036315. Also, as disclosed in Japanese Patent Application Kokai Publication No. 2004-282549, there is one in which a washer with a temporary joint function is previously attached to a convex portion.

The conventional vehicle roof antenna mounting assemblies described above, however, have some problems as follows. That is, since the antenna base plate and the nut for tightening are separated, and it is necessary to screw the nut to the convex portion through the roof panel from the vehicle interior, there is a possibility that, for example, the nut falls out undesirably when the mounting assembly is mounted. Therefore, the conventional mounting assemblies have extremely low operability for mounting it to the roof panel, and force operators to bear the burden.

An object of the present invention, therefore, is to overcome the problems existing in the prior art, and to provide a vehicle roof antenna mounting assembly which can easily be mounted to a vehicle, and in which an operator's burden can be reduced.

### SUMMARY OF THE INVENTION

According to one aspect of the invention, there is provided a vehicle roof antenna mounting assembly fixed by inserting a part of the mounting assembly from an outside of a vehicle through a mounting hole formed through a vehicle roof panel so as to catch the vehicle roof panel, the mounting assembly comprising: an antenna base disposed on an outside of the vehicle roof panel of the vehicle; a convex portion formed on a surface of the vehicle roof panel side of the antenna base, inserted into the mounting hole, and having a surface portion surrounding a first screw and a peripheral portion thereof, the surface portion having an edge portion; a tightening member having a second screw screwed with the first screw, and tightened to the convex portion; a leg washer having a plate washer ring through which one of the first screw and the second screw is passed, a leg portion extendedly provided from the washer ring toward the mounting hole, and a taper portion provided on the leg portion as opposed to the edge portion of the surface portion, the taper portion being abutted on the edge portion to expand the tip portion toward an outside of the mounting hole in accordance with which the washer ring is come close to the mounting hole by tightening the tightening member.

The leg portion may be formed flatly, and the taper portion may be extendedly provided on a side of the leg portion.

The taper portion may be formed by bending at least a part of said leg portion inwardly.

The taper portion may be formed to be released from abutting on the edge portion in a condition where the tightening member is completely tightened to the convex portion.

The tip portion may be bended to be abutted perpendicularly on the vehicle roof panel in a condition where the tightening member is completely tightened to the convex portion.

The vehicle roof antenna mounting assembly may further comprise a temporary joint member provided between the convex portion and the leg washer, the temporary joint member comprising: a sandwiched support member sandwiched between the convex portion and the washer ring; an elastic temporary joint leg having a toe portion and an arm portion, and extendedly provided from the sandwiched support member toward the mounting hole, the toe portion being disposed on the outside of the vehicle roof panel in a condition where the vehicle roof antenna mounting assembly is mounted; and a fastening portion formed such that at least a part between the toe portion and the arm portion is disposed on the outside of the mounting hole on an inside of the vehicle roof panel.

According to the invention, since the vehicle roof antenna mounting assembly can be mounted by an extremely easy operation in which the protruding tightening member such as a bolt is only tightened from the vehicle interior, operator's burden can greatly be reduced.

### BRIEF DESCRIPTION OF THE DRAWINGS

The above and other objects, features and advantages of the present invention will be apparent from the following description of preferred embodiments of the invention explained with reference to the accompanying drawings, in which:

FIG. 1 is an exploded perspective view showing a vehicle roof antenna mounting assembly according to an embodiment of the invention;

FIG. 2 is a partially cross sectional perspective view showing a leg washer assembled in the vehicle roof antenna mounting assembly according to the invention;

FIG. 3 is a perspective view showing a condition where a temporary joint member is attached to a convex portion of an antenna base assembled in the vehicle roof antenna mounting assembly according to the invention;

FIG. 4 is a longitudinal sectional view showing a condition where the vehicle roof antenna mounting assembly is tightened temporarily to a vehicle roof panel according to the invention;

FIG. 5 is a longitudinal sectional view showing a condition where the vehicle roof antenna mounting assembly is tightened completely according to the invention;

FIG. 6 is a longitudinal sectional view showing a condition before tightening a screw for explaining a miniaturization principle of the vehicle roof antenna mounting assembly according to the invention;

FIG. 7 is a longitudinal sectional view showing a condition after tightening a screw for explaining a miniaturization principle of the vehicle roof antenna mounting assembly according to the invention; and

FIG. 8 is a longitudinal sectional view showing a modified example of the leg washer assembled in the vehicle roof antenna mounting assembly according to the invention.

### PREFERRED EMBODIMENTS OF THE INVENTION

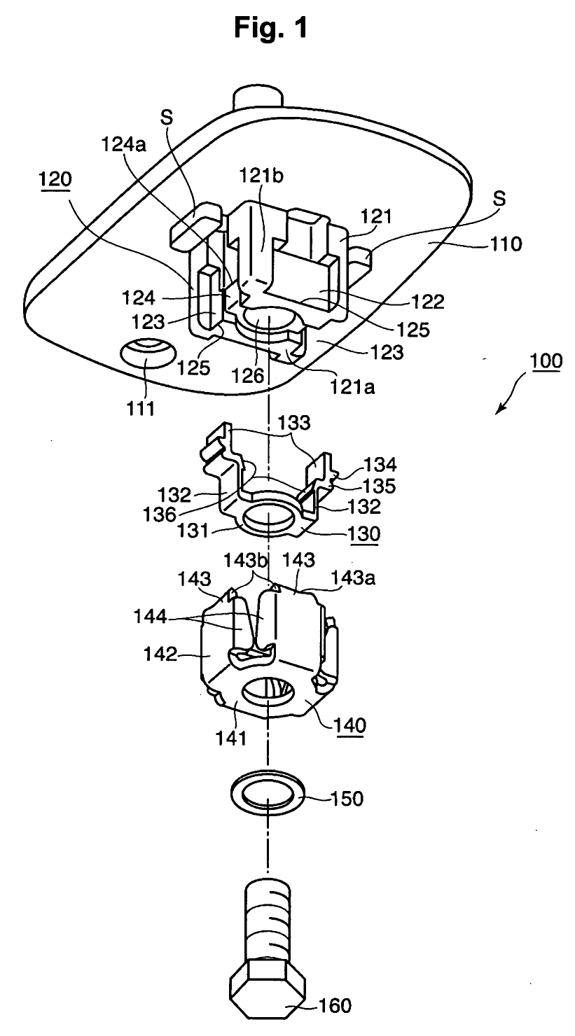

Now, an embodiment according to the invention is explained with reference to the drawings. FIG. 1 shows a vehicle roof antenna mounting assembly 100 according to a first embodiment of the present invention. This figure is an exploded perspective view showing components needed for mounting the mounting assembly to a vehicle roof panel R through a mounting hole RH to be described hereinafter. In FIG. 1, a symbol S depicts a position of the mounting assembly to be abutted on the vehicle roof panel.

The vehicle roof antenna mounting assembly 100 includes an antenna base 110, a convex portion 120, a temporary joint member 130, a leg washer 140, a plate washer 150, and a bolt 160. The antenna base 110 is disposed on an upper side of the vehicle roof panel R. The convex portion 120 is formed integrally on a bottom surface of the antenna base 110. The temporary joint member 130 is attached to the convex portion 120. The leg washer 140 having leg portions 142 is made of metal and tightened to the convex portion 120. The bolt 160, i.e., a tightening member or a second screw tightens the leg washer 140 and the plate washer 150 to the convex portion 120.

An antenna mast not shown is attached to the antenna base 110. The antenna base 110 has an opening 111 for passing a kind of cable therethrough.

The convex portion 120 has a convex body 121 of a quadrangular cylinder shape. A bottom surface 121a, i.e., a surface portion of the convex body 121 is parallel to the vehicle roof panel R, and sidewall surfaces 121b are perpendicular to the vehicle roof panel R. The sidewall surfaces 121b have two pairs of notches 122, 122, 123, 123. Each of the notches 123, 123 also has other notches 124, 124, and a step 124a which is hooked on a latch 136 to be described hereinafter. There are edge portions 125 each at an intersection between the bottom surface 121a and the bottom of the notches 122, 122, 123, 123. An internal threaded hole 126, i.e., a first screw is formed on a central axis of the convex portion 120.

The temporary joint member 130 is made of resin, metal, etc. having elasticity. The temporary joint member 130 has a ring body 131, i.e., a sandwiched support member which is fitted into a top of the convex portion 120, and a pair of joint legs 132 which is extendedly provided as opposed to each other from the ring body 131. The joint legs 132 are formed to fit into the notches 124 described above. A toe portion 133 of each of the joint leg is formed to abut on an inner face of the mounting hole RH. A fastening portion 134 and a release knob 135 larger in diameter than the mounting hole RH are formed on a part of each of the joint legs 132. The latch 136 is formed on an inner face of each of the joint legs 132 and hooked on the step 124a described above. Therefore, it can be prevented that the temporary joint member 130 falls off from the convex portion 120, so that the operability can be improved.

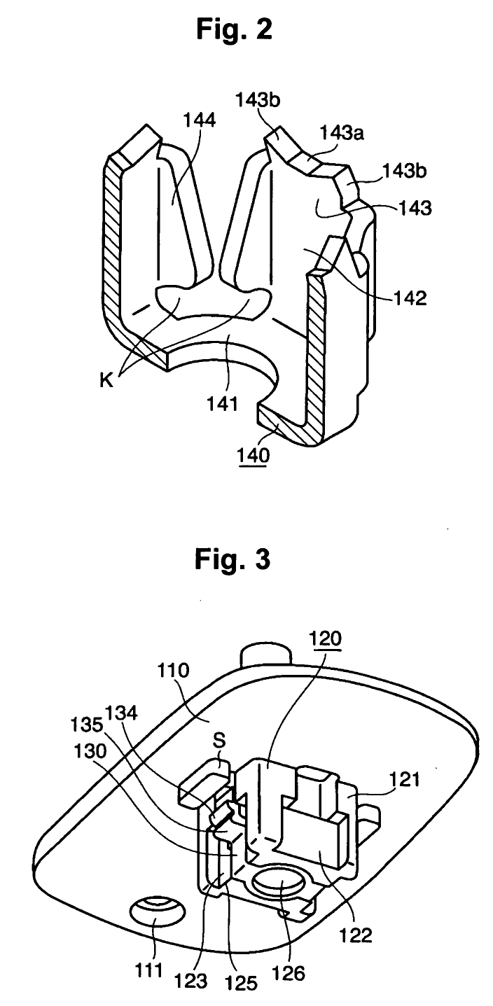

The leg washer 140 is formed by a pressing process after metal, e.g., low-carbon steel is punched. The leg washer 140 has a plate washer ring 141 and four plate leg portions 142 extendedly provided from the washer ring 141. The leg portions 142 are disposed corresponding to the notches 122, 123 described above, respectively. A diameter of a peripheral shape formed by the leg portions 142 is made as slightly smaller than an inner diameter of the mounting hole RH described above. As shown in FIG. 2, a tip portion 143 of each of the leg portions 142 is formed to be somewhat bended inwardly, and has a flat portion 143a formed linearly and claw portions 143b disposed on both ends thereof.

A taper portion 144 is extendedly provided on a side surface of each of the leg portions 142. The taper portion 144 is formed as opposed to the edge portion 125 so that an inner diameter formed by the taper portions expands from the washer ring 141 side to the tip portion 143 side. That is, the taper portion 144 is tapered from the washer ring side to the tip portion side. The taper portion 144 is abutted on the edge portion 125, and designed such that an inner diameter formed by the tip portions 143 is gradually expanded as contrasted with the leg portion 142, that is, the tip portions is gradually expanded from the original position of the leg portion 142 toward an outside of the mounting hole RH by tightening the bolt 160. The taper portion 144 is also formed to have a little space K spaced with the washer ring 141.

Next, an operation for mounting the vehicle roof antenna mounting assembly 100 to the vehicle roof panel R is explained hereunder. First of all, as shown in FIG. 3, the temporary joint member 130 is assembled to the convex portion 120. The leg washer 140 and the plate washer 150 are then assembled by the bolt 160 screwed lightly.

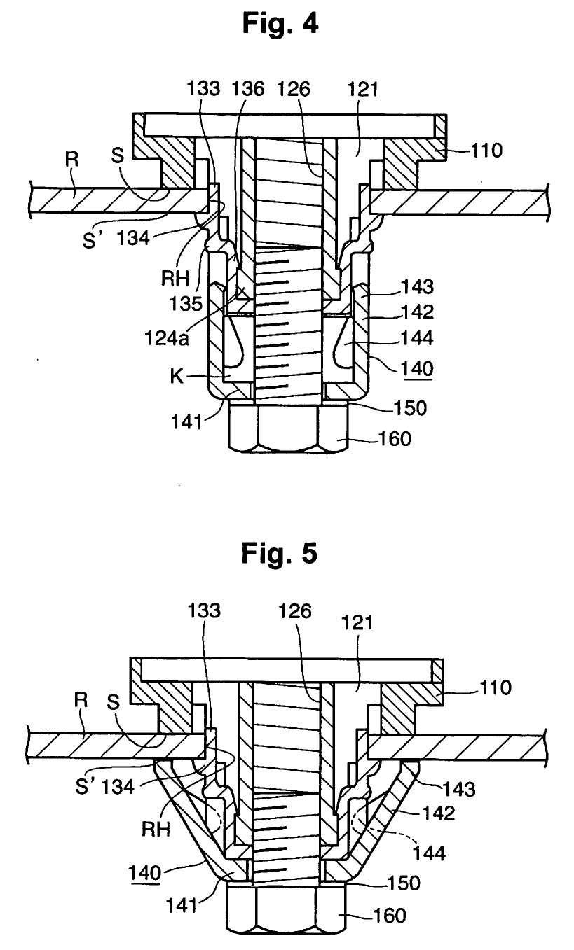

In this condition, the convex portion 120 is inserted into the mounting hole RH from the upper side of the vehicle roof panel R as shown in FIG. 4. At this time, since the tip of the leg portion 142 of the leg washer 140 is fitted into each of the notches 122, 122, 123, 123, there is no obstacle to insert the convex portion into the mounting hole RH. Though the fastening portion 134 of the temporary joint member 130 is projected to the outside of the mounting hole RH, it can be inserted through the mounting hole RH because the joint leg 132 has enough elasticity. That is, when the temporary joint member 130 is inserted into mounting hole RH, the joint leg 132 is flexed temporarily to the inside with some loads. When the fastening portion 134 is passed completely through the mounting hole RH, the joint leg 132 is returned to the original state with elasticity, and then the fastening portion 134 is again projected to the outside of the mounting hole RH.

The convex portion 120 is jointed temporarily to the vehicle roof panel R when the fastening portion 134 is projected. Thus, the antenna base 110 cannot be removed from the vehicle roof panel R unless an operator pinches the fastening portion 134 of the temporary joint member 130 to push it out from a vehicle interior. Also, since the release knob 135 is provided on each of the joint legs, even if the antenna base 110 has to be removed because of component replacement, the temporary joint member 130 can easily be removed by pinching the release knobs 135 from both sides to release the fastening portion 134 from the vehicle roof panel R after removing the leg washer 140 by loosening the bolt 160.

Next, where the operator tightens the bolt 160 from the vehicle interior, a shaft length of the bolt 160 to the antenna base 110 is shortened, so that whole of the leg washer 140 is pressed toward the vehicle roof panel R.

In this condition, the inner face of the taper portion 144 formed on each of the leg portions 142, 142 of the leg washer 140 is particularly abutted on the edge portion 125 of the convex portion 120. Therefore, the inner diameter formed by the tip portions 143 is gradually expanded while the bolt 160 is tightened. That is, the tip portions 143 are expanded toward an outside of the mounting hole RH. As a result, as shown in FIG. 5, a space between the tip portions 143, 143 is more expanded than the inner diameter of the mounting hole RH. The tip portion 143 is also abutted on the vehicle roof panel R from the vehicle interior side at an abutted position S′ as shown in FIG. 5.

In this condition, since the tip portion 143 of the leg portion 142 is bended inwardly to the leg portion 142, the tip portion 143 is perpendicularly abutted on the abutted position S′ of the vehicle roof panel R when the leg portions are expanded. The roof panel R is not deformed owing to the abutting of the tip portions 143, because there is the abutted portion S of the antenna base 110 on the outside of the roof panel R and the roof panel R is sandwiched on both sides thereof by the abutted portion S′ of tip portions 143 and the abutted portion S of the antenna base 110. Also, since the space K is provided, there is no force from the edge portion 125 to the taper portion 144 for expanding the leg portions 142 in a condition where the tightening member is tightened completely. Therefore, tightening force to the bolt 160 becomes tremendous pressing force to the vehicle roof panel R for the tip portion 143 in a perpendicular direction, so that electrical connectivity between the tip portion 143 and the vehicle roof panel R can be made certain.

Further, since the tip portion 143 is provided with the flat portion 143a with an enough width, a contact region can be made large. Also, since the claw portions 143b are made sharp, the claw portions bite into the vehicle roof panel R strongly.

Therefore, even if the abutted position S′ on the bottom surface of the vehicle roof panel R is coated by paint, etc., and the leg washer 140 is intended for using as an electrical transmission line such as a grounding for one part of the antenna, it is possible to electrically connect to the vehicle roof panel R certainly to prevent a contact failure.

As explained above, the present vehicle roof antenna mounting assembly 100 can be mounted by an extremely easy operation in which the protruding bolt 160 is only tightened from the vehicle interior after jointing temporarily. Moreover, since the bolt 160 is assembled into the antenna base 110 in advance, there is no possibility that the nut falls out toward the vehicle interior, so that the mounting assembly according to the present invention can reduce the operator's burden greatly.

The leg portions 142 are formed to be in parallel with each other at first, and are expanded to be tightened to the convex portion. The leg portion 142 is therefore fixed strongly to the convex portion 120 with its elastic force, and also has an effect of preventing slacking of the bolt. Furthermore, the edge portion 125 and the taper portion 144 are in friction with each other, the fixing force is made stronger.

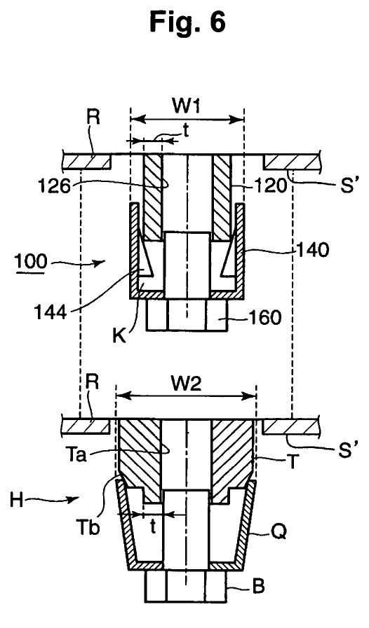

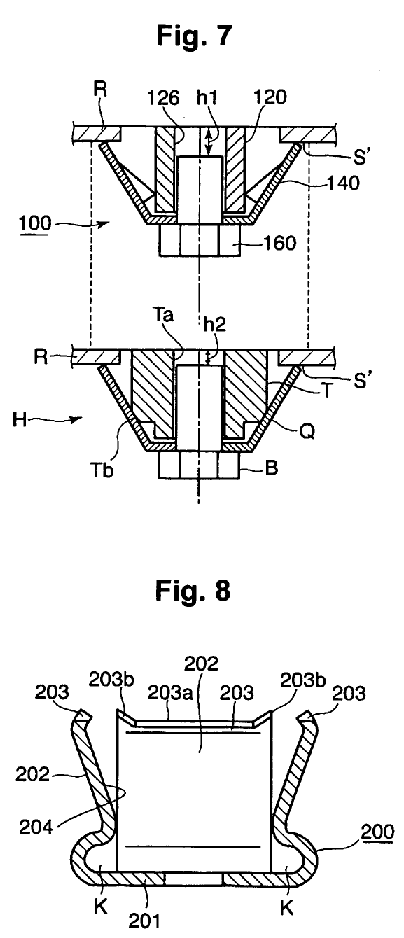

The mounting assembly in which the taper portion is provided on the leg washer side can be made smaller than that is provided on the convex portion side. The reason for that is explained with reference to FIGS. 6 and 7. It is explained using a comparison example of a vehicle roof antenna mounting assembly H in which the taper portion is provided on the convex portion side. The vehicle roof antenna mounting assembly H includes a convex portion T, a leg washer Q and a bolt B. The convex portion T includes an internal threaded hole Ta and a taper portion Tb. In the figures, a symbol S′ depicts a position of the leg washer Q to be abutted on the vehicle roof panel R. The diameters of the bolt 160 and the bolt B, and the abutted positions S′ are the same as each other, respectively.

It is necessary to have a minimum wall thickness t of each of the convex portion 120 and the convex portion T screwed by the bolt 160 and the bolt B respectively for ensuring strength during the screwing. For ensuring the minimum wall thickness t, the convex portion T of the comparison example should be designed such that a minimum outer diameter portion of the taper portion Tb has at least the wall thickness t. Therefore, it is necessary to be designed such that the outer diameter of the convex portion T becomes gradually large from the wall thickness t. As compared thereto, since there is no taper portion on the convex portion 120 of the embodiment, there is no need to enlarge the outer diameter of the convex portion 120 as long as the minimum wall thickness t is ensured.

For the above reason, as shown in FIG. 6, a maximum outer diameter of the convex portion T of the comparison example is larger than that of the convex portion 120 of the embodiment. Accordingly, the maximum diameter W2 of the leg washer Q is also larger than that W1 of the leg washer 140. On the other hand, since the distance from the central axis of the leg washer 140 to the taper portion 144 is shorter than that from the central axis of the leg washer Q to the taper portion Tb, an amount to be tightened to the abutted position S′ during the expanding of the leg portions becomes smaller than that in the comparison example as shown in FIG. 7. That is, the distance h1 is larger than that h2. Thus, a height of the convex portion 120 can be made shorter than that of the convex portion T. Therefore, the vehicle roof antenna mounting assembly 100 can be made smaller than the vehicle roof antenna mounting assembly H of the comparison example.

In the above embodiment, the leg portions 142 of the leg washer 140 are four legs, but are not limited thereto, and the leg portions 142 may even be three legs or five legs or more. Though the convex body 121 of the convex portion 120 is in a quadrangular cylinder shape, it may also be in a cylinder shape such as a circular cylinder shape, a triangular cylinder shape and a hexagonal cylinder shape. The plate washer 150 uniformly provides the tightening force of the bolt 160 to the leg washer 140, and has an effect of preventing slacking of the bolt. However, it is not limited thereto, and the plate washer 150 may be omitted by providing the leg washer 140 with the effect thereof. Further, though the leg washer 140 and the temporary joint member 130 are separated with each other in the above embodiment, it may be made as one body.

FIG. 8 shows a longitudinal sectional view of a leg washer 200 as a modified example of the leg washer 140 assembled into the above vehicle roof antenna mounting assembly 100 according to a second embodiment of the invention.

The leg washer 200 includes a plate washer ring 201 and four plate leg portions 202. The washer ring 201 has an opening to pass the bolt 160 therethrough at the center thereof. The leg portions 202 are extendedly provided from the washer ring 201. The leg washer 200 is formed by a pressing process after metal, e.g., low-carbon steel is punched.

The leg portions 202 are formed to be disposed corresponding to the above notches 122, 123, respectively. The tip portion 203 of each of the leg portions 202 is formed to be somewhat bended inwardly. The tip portion 203 has a flat portion 203a formed linearly and claw portions 203b disposed on both ends thereof. As shown in FIG. 8, each of the leg portions 202 is bended inwardly to form a taper face 204. The taper face 204 is provided as opposed to each of the edge portions 125, and is formed such that an inner diameter formed by the leg portions is expanded from the washer ring 201 side to the tip portion 203 side. That is, the taper face 204 is abutted on the edge portion 125, and designed such that a force is provided to a direction in which the tip portions 203 are gradually expanded as contrasted with each of the leg portions 202. The taper face 204 is also formed to have a little space K spaced with the washer ring 201.

The operation for mounting the vehicle roof antenna mounting assembly 100 on the vehicle roof panel R using the leg washer 200 according to the modified example is the same as that using the leg washer 140 of the first embodiment. For the leg washer 200, when the bolt 160 is screwed, the taper face 204 of each of the leg portions 202 is abutted on each the edge portions 125, so that the leg portions 202 are opened with each other.

In the second embodiment as well as the first embodiment of the invention, since the vehicle roof antenna mounting assembly can easily be mounted temporarily, and can be fixed only by an extremely easy operation in which the protruding bolt 160 is only tightened from the vehicle interior, operator's burden can greatly be reduced.

While the invention has been described in its preferred embodiments, it is to be understood that the words which have been used are words of description rather than limitation and that changes within the purview of the appended claims may be made without departing from the true scope of the invention as defined by the claims. For example, in the above embodiments, the internal threaded hole as the first screw is provided to the convex portion 120 side and the external screw as the second screw is provided to the bolt 160 side. However, the external screw as the first screw may be provided to the convex portion 120 side and the leg washer 140 may be threaded by the nut with the internal threaded hole as the second screw.

What is claimed is:

1. A vehicle roof antenna mounting assembly fixed by inserting a part of the mounting assembly from an outside of a vehicle through a mounting hole formed through a vehicle roof panel so as to catch said vehicle roof panel, said mounting assembly comprising:
an antenna base disposed on an outside of said vehicle roof panel of said vehicle;
a convex portion formed on a surface of the vehicle roof panel side of said antenna base, inserted into said mounting hole, and having a surface portion surrounding a first screw and a peripheral portion thereof, said surface portion having an edge portion;
a tightening member having a second screw screwed with said first screw, and tightened to said convex portion;
a leg washer having a plate washer ring through which one of said first screw and said second screw is passed, a leg portion extendedly provided from said washer ring toward said mounting hole, and a taper portion provided on said leg portion as opposed to said edge portion of said surface portion, said taper portion being abutted on said edge portion to expand said tip portion toward an outside of said mounting hole in accordance with which said washer ring is come close to said mounting hole by tightening said tightening member.

2. The vehicle roof antenna mounting assembly according to claim 1, in which
said leg portion is formed flatly, and
said taper portion is extendedly provided on a side of said leg portion.

3. The vehicle roof antenna mounting assembly according to claim 1, in which said taper portion is formed by bending at least a part of said leg portion inwardly.

4. The vehicle roof antenna mounting assembly according to claim 1, in which said taper portion is formed to be released from abutting on said edge portion in a condition where said tightening member is completely tightened to said convex portion.

5. The vehicle roof antenna mounting assembly according to claim 1, in which said tip portion is bended to be abutted perpendicularly on said vehicle roof panel in a condition where said tightening member is completely tightened to said convex portion.

6. The vehicle roof antenna mounting assembly according to claim 1, which further comprising a temporary joint member provided between said convex portion and said leg washer, said temporary joint member comprising:
a sandwiched support member sandwiched between said convex portion and said washer ring;
an elastic temporary joint leg having a toe portion and an arm portion, and extendedly provided from said sandwiched support member toward said mounting hole, said toe portion being disposed on said outside of said vehicle roof panel in a condition where said vehicle roof antenna mounting assembly is mounted; and
a fastening portion formed such that at least a part between said toe portion and said arm portion is disposed on the outside of said mounting hole on an inside of said vehicle roof panel.
